(19) United States
(12) Patent Application Publication
(10) Pub. No.: US 2012/0025654 A1
(43) Pub. Date: Feb. 2, 2012

(54) ROTOR OF A PERMANENT MAGNET SYNCHRONOUS MACHINE

(75) Inventors: Dominik Bach, Bad Neustadt (DE); Daniel Mader, Bad Neustadt (DE); Rolf Vollmer, Gersfeld (DE)

(73) Assignee: Siemens Aktiengesellschaft, Munchen (DE)

(21) Appl. No.: 13/018,920

(22) Filed: Feb. 1, 2011

(30) Foreign Application Priority Data
Feb. 2, 2010 (DE) 10 2010 001 481.8

(51) Int. Cl. H02K 1/28

(52) U.S. Cl. 310/156.31

(57) ABSTRACT

A rotor for a permanent magnet synchronous machine includes a basic body defining a center. Permanent magnets are arranged on a circumferential surface of the basic body to thereby form magnetic poles. Each magnetic pole is formed in a circumferential direction by at least two permanent magnets and defined by a pole center and a pole edge, wherein the pole edge is spaced from the center of the basic body at a distance which is smaller than a distance of the pole center to the center of the basic body. Positioned in sections between the pole centers of adjacent pole are filling elements, with a banding securing the filling elements on the permanent magnets in such a way that the rotor has a substantially cylindrical circumferential surface.

### CROSS-REFERENCES TO RELATED APPLICATIONS

This application claims the priority of German Patent Application, Serial No. 10 2010 001 481.8, filed Feb. 2, 2010, pursuant to 35 U.S.C. 119(a)-(d), the content of which is incorporated herein by reference in its entirety as if fully set forth herein.

### BACKGROUND OF THE INVENTION

The present invention relates to a rotor of a permanent magnet synchronous machine, and more particularly for a rotor of a permanent magnet synchronous machine operating at high rotation speeds.

The following discussion of related art is provided to assist the reader in understanding the advantages of the invention, and is not to be construed as an admission that this related art is prior art to this invention.

Dynamoelectric permanent magnet synchronous machines for high circumferential speeds usually have high core losses and eddy current losses. This results in undesirably high degrees of heating in the laminate stack of the stator and rotor and on the permanent magnets of the rotor. The total losses involve losses generated by the fundamental and losses generated by the harmonics. If the losses as a result of harmonics are reduced, overall less heating is achieved. With the same level of heating, however, it is also possible for relatively high fundamental losses to be permitted and therefore also for a relatively high output power to be achieved.

In order to reduce losses as a result of harmonics, synchronous machines have been constructed with comparatively low air-gap induction. In addition to the harmonic induction, however, the fundamental induction is therefore also comparatively low. As the torques are approximately proportional to the induction of the fundamental, only comparatively low motor torques are possible, given a permissible level of the total losses.

It would therefore be desirable and advantageous to provide an improved rotor for a permanent magnet synchronous machine which rotor obviates prior art shortcomings and has comparatively low harmonic induction, and which is easy to install and is able to absorb centrifugal forces at high circumferential speeds.

### SUMMARY OF THE INVENTION

According to one aspect of the present invention, a rotor for a permanent magnet synchronous machine includes a basic body defining a center, permanent magnets arranged on a circumferential surface of the basic body to thereby form magnetic poles, each magnetic pole being formed in a circumferential direction by at least two permanent magnets and defined by a pole center and a pole edge, wherein the pole edge is spaced from the center of the basic body at a distance which is smaller than a distance of the pole center to the center of the basic body, a filling element positioned in sections between the pole centers of adjacent poles, and a banding securing the filling element on the permanent magnets in such a way that the rotor has a substantially cylindrical circumferential surface.

Enlarging the magnetic air gap at the pole edges results in a reduction in the harmonics of the magnetic air-gap field of the permanent magnet synchronous machine. Thus, eddy current losses and hysteresis losses in the core of the stator and the rotor are reduced. By virtue of splitting a magnetic pole advantageously into a plurality of isolated individual magnets, eddy current losses in the electrically conductive permanent magnets are additionally reduced. This results in dynamoelectric machines with a comparatively high power.

A magnetic pole, when viewed in the circumferential direction, is split advantageously into two or five sections or individual magnets. Less favorably, it is split into three or four magnets in the circumferential direction per magnet pole since disruptive harmonics with the fifth or seventh of the fundamental are therefore produced which have an extremely negative effect on the torque ripple.

In order that the torque ripple is thus virtually uniform, further-reaching, known measures, such as skewing of the magnetic pole, for example, can be dispensed with, which simplifies the manufacture of the rotor and therefore reduces costs.

By virtue of the filling elements and the banding, a virtually cylindrical circumferential surface of the rotor is now provided. Owing to this now cylindrical circumferential surface of the rotor, air friction losses, in particular at high rotation speeds, in the air gap of the permanent magnet synchronous machine are kept comparatively low during operation of said machine.

Rotors in accordance with the present invention, can be used in particular in permanent magnet synchronous machines that operate at rotation speeds of up to 70,000 rpm and above.

According to another aspect of the present invention, a permanent magnet synchronous machine includes a rotor having a basic body defining a center, permanent magnets arranged on a circumferential surface of the basic body to thereby form magnetic poles, each magnetic pole being formed in a circumferential direction by at least two permanent magnets and defined by a pole center and a pole edge, wherein the pole edge is spaced from the center of the basic body at a distance which is smaller than a distance of the pole center to the center of the basic body, a filling element positioned in sections between the pole centers of adjacent poles, and a banding securing the filling element on the permanent magnets in such a way that the rotor has a substantially cylindrical circumferential surface, and a stator having a stator bore for receiving with the rotor such that a geometrical air gap is defined between the banding and stator bore, with the air gap being substantially identical when viewed in the circumferential direction.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross sectional view of one embodiment of a rotor according to the present invention;

FIG. 2 is a basic illustration of a rotor according to the present invention received in a stator; and

FIG. 3 is a cross sectional view of another embodiment of a rotor according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

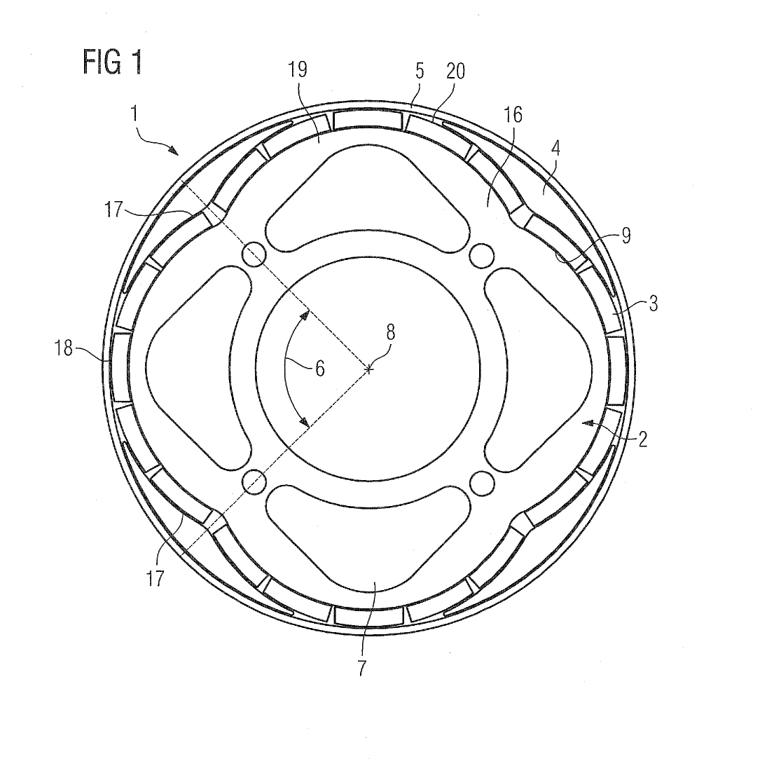

Turning now to the drawing, and in particular to FIG. 1, there is shown a cross sectional view of one embodiment of a rotor according to the present invention, generally designated by reference numeral 1. The rotor 1 has a basic body 16 made of layered laminates 2 and having cutouts 7 for cooling on one hand, and providing reduced inertia of the rotor 1 on the other hand. This is advantageous in particular for a dynamic operating response. Permanent magnets 3 are located on the surface of the basic body 16. In the non-limiting example of FIG. 1, five permanent magnets 3, when viewed in the circumferential direction, form a magnetic pole 6. The rotor 1, shown in FIG. 1, involves a four-pole rotor 1. The pole pitch factor, which influences harmonic levels, is below 100% in the present exemplary embodiments.

Further permanent magnets 3 are provided correspondingly in the axial direction of a magnetic pole 6, depending on the axial length of the rotor 1 or the geometric dimension of a permanent magnet 3.

Advantageously, the permanent magnets 3 of a magnetic pole 6 are insulated with respect to one another in order to reduce eddy current losses. For example, the permanent magnets 3 may be provided with a suitable coating 20.

This basic body 16 has outwardly curved positions 19 in the region of the poles 6. By arranging permanent magnets 3 on the outwardly curved portions 19, a pole center 18 of the permanent magnet 3 is spaced from a center 8 of the basic body 16 at a distance which differs from a distance between the pole center 18 and a pole edge 17.

When the rotor 1 has been installed in a stator bore 14 of a permanent magnet synchronous machine, a different magnetic air gap is produced, when viewed in the circumferential direction. The magnetic air gap is smaller in the pole center 18 than at the pole edges 17.

In order to secure the permanent magnets 3 with respect to centrifugal forces, a banding 5 is provided which primarily holds however the permanent magnet(s) 3 in the region of the pole center 18. At high circumferential speeds, the pole edges 17 would therefore be subjected to the centrifugal forces. In order to be able to absorb the centrifugal forces acting on the permanent magnets 3 in the region of the pole edge 17 or in the pole gap, in particular at high speeds, filling elements 4 are arranged in accordance with the present invention in the region of these pole gaps, i.e. between the pole centers 18 of adjacent poles 6.

As a result of the presence of the filling elements 4, the surface of the rotor 1 is configured so as to be cylindrical. The banding 5 is hereby able to press the filling elements 4 onto the permanent magnets 3 located in particular in the region of the pole edge, to thereby attain a sufficient hold for these permanent magnets 3 on the basic body of the rotor 1 in particular when high circumferential speeds are involved. The banding 5 can be made of metal, for example steel, or a fiber composite material, for example glass fiber-reinforced plastic, or carbon fiber-reinforced plastic. Advantageously, the magnet pitch per pole 6 in the circumferential direction comprises two or five permanent magnets 3. Advantageously, the permanent magnets 3 are identical and have a radius of curvature which conforms to a radius of curvature of the outwardly curved portion 19.

Pitches of three or four permanent magnets are less desired because the harmonics of the fifth and seventh of the fundamental are thus produced.

In the axial direction of the rotor 1, the number of permanent magnets 3 is dependent inter alia on the axial length or ease of use.

With these advantageous magnetic pitches, the torque ripple is further reduced so that the need for conventional measures such as skewing of the magnetic poles 6 in the axial profile of the rotor 1 is eliminated. This results in a further reduction in manufacturing costs.

The filling elements 4 can be made of reinforced thermosetting plastics. Thermosetting plastics are plastics which can no longer be deformed after being cured. They are glass-like, hard polymeric materials, with three-dimensional crosslinking resulting when mixing fabricated materials. These include aminoplasts, phenolic resins, and also epoxy resins. Advantages of this material are comparatively high thermomechanical strength and low specific weight in comparison with metal. Thus, the inertia of the rotor 1 during dynamic operation of the dynamoelectric machine is further reduced.

Furthermore, high-temperature thermoplasts may also be suitable for use as filling elements 4. Thermoplasts are plastics which can be deformed thermoplastically in a specific temperature range. Suitable filling elements 4 are in particular polyamides (PA), polyetheretherketone (PEEK) and polypropylenestyrene (PPS).

Together with a high-strength banding 5, which is provided on the outer circumference of the rotor 1, high rotation speeds of over 70,000 rpm of the dynamoelectric machine become possible.

The filling elements 4 can be applied as prefabricated preforms or in shapeless fashion to the basic body 16, which is provided with permanent magnets 3, and possibly brought into their shape in supplementary fashion by the banding 5. Casting with low-viscosity filled artificial resins or cement-like, filled artificial resins or softened, filled thermoplastics are in particular suitable for shapeless application.

Filled thermoplastics and thermosetting plastics are particularly suitable for use as filling elements 4 since they have a coefficient of thermal expansion which is similar to that of steel and a ratio of density to modulus of elasticity which is similar to that of steel. Good interaction between banding 5 and such a filling element 4 is thus provided.

Owing to the filling elements 4, a cylindrical or substantially cylindrical shape of the rotor 1 is produced and a uniformly high contact pressure on the permanent magnets 3 during application of the banding is thus achieved. This also results in a reduction in the air friction losses in the geometrical air gap 13 of the dynamoelectric machine as a result of the precise cylindrical shape.

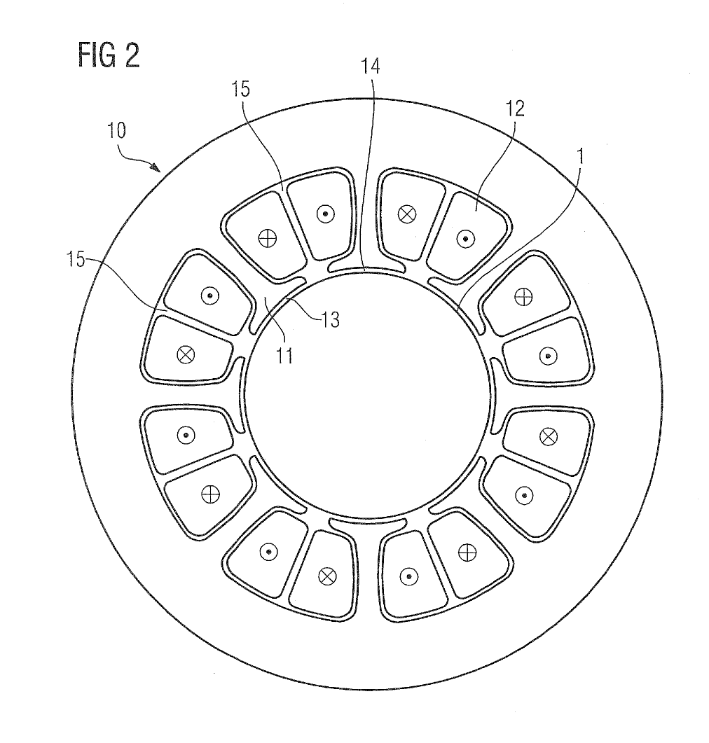

FIG. 2 shows, in a basic illustration, a rotor 1 in a stator bore 14 of a permanent magnet synchronous machine (not illustrated in any more detail), the stator 10 having teeth 11, which point radially inwards, are surrounded in this case by a respective tooth-wound coil 12 and induce a magnetic field during operation, said magnetic field interacting with the rotor 1 and therefore generating a torque.

As an alternative to this, the winding system of the dynamoelectric machine can of course also have a conventional configuration, i.e. be configured with chorded coils, in which case the forward and return conductors of a coil are not located in adjacent slots 15.

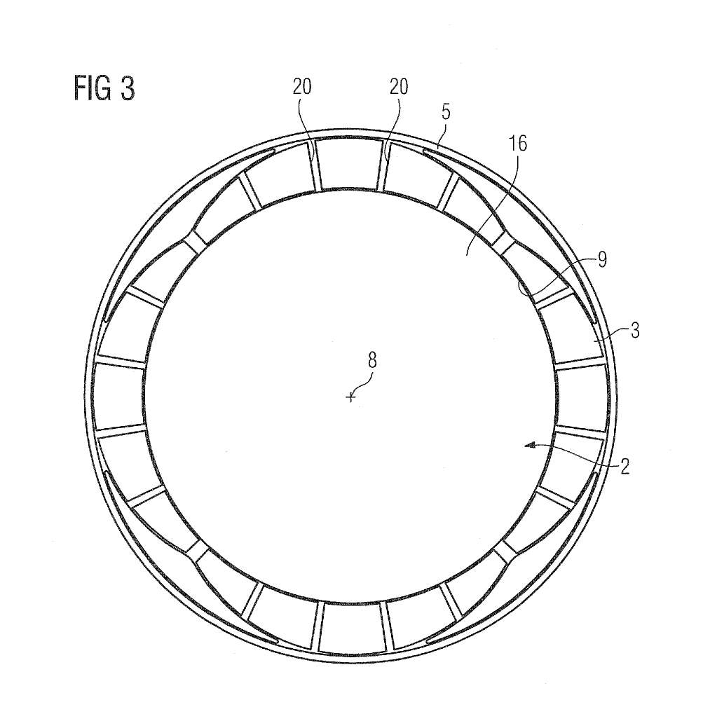

FIG. 3 shows an alternative embodiment of a rotor 1 according to the invention, in which the basic body 16 of the rotor 1 is cylindrical, but a different magnetic air gap, when viewed in the circumferential direction, is achieved as a result of differently shaped permanent magnets 3 of a magnetic pole 6. In design terms, like in the embodiment shown in FIG. 1, centrifugal forces are absorbed during operation by filling elements 4 and banding 5 and a cylindrical shape of the rotor 1 is achieved.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A rotor for a permanent magnet synchronous machine, said rotor comprising:
a basic body defining a center;
permanent magnets arranged on a circumferential surface of the basic body to thereby form magnetic poles, each magnetic pole being formed in a circumferential direction by at least two permanent magnets and defined by a pole center and a pole edge, wherein the pole edge is spaced from the center of the basic body at a distance which is smaller than a distance of the pole center to the center of the basic body;
a filling element positioned in sections between the pole centers of adjacent poles; and
a banding securing the filling element on the permanent magnets in such a way that the rotor has a substantially cylindrical circumferential surface.

2. The rotor of claim 1, wherein the filling element is a reinforced thermosetting plastic or a high-temperature thermoplastic.

3. The rotor of claim 1, wherein the filling element is applied as a preform or in shapeless fashion between the pole centers of the rotor.

4. The rotor of claim 1, wherein the banding is made of metal or a fiber composite material.

5. The rotor of claim 1, wherein each magnetic pole, when viewed in the circumferential direction, has five permanent magnets.

6. The rotor of claim 1, wherein the basic body has a cylindrical configuration, and the permanent magnets are formed in such a way that the pole edge is spaced from the center of the basic body at a distance which is smaller than a distance of the pole center to the center of the basic body.

7. The rotor of claim 1, wherein the basic body is provided with outwardly curved positions for placement of the permanent magnets of complementary shape and thickness, said permanent magnets forming magnetic poles so that the distance at the pole edge from the center of the basic body is less than the distance from the pole center to the center of the basic body.

8. A permanent magnet synchronous machine, comprising:
a rotor including a basic body defining a center, permanent magnets arranged on a circumferential surface of the basic body to thereby form magnetic poles, each magnetic pole being formed in a circumferential direction by at least two permanent magnets and defined by a pole center and a pole edge, wherein the pole edge is spaced from the center of the basic body at a distance which is smaller than a distance of the pole center to the center of the basic body, a filling element positioned in sections between the pole centers of adjacent poles, and a banding securing the filling element on the permanent magnets in such a way that the rotor has a substantially cylindrical circumferential surface; and
a stator having a stator bore for receiving with the rotor such that a geometrical air gap is defined between the banding and stator bore, said air gap being substantially identical when viewed in the circumferential direction.
